(19) United States
(12) Patent Application Publication
(10) Pub. No.: US 2025/0202980 A1
(43) Pub. Date: Jun. 19, 2025

(54) INFORMATION PROCESSING METHOD, COMMUNICATION SYSTEM, AND INFORMATION PROCESSING PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP); TOYOTA JIDOSHA KABUSHIKI KAISHA, Toyota-Shi, Aichi (JP)

(72) Inventors: Yuichi Kodama, Yokkaichi-shi, Mie (JP); Makoto Chujo, Osaka-shi, Osaka (JP); Isao Watanabe, Toyota-shi, Aichi (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP); TOYOTA JIDOSHA KABUSHIKI KAISHA, Toyota-Shi, Aichi (JP)

(21) Appl. No.: 18/848,077

(22) PCT Filed: Mar. 13, 2023
(86) PCT No.: PCT/JP2023/009536

§ 371 Date: Sep. 17, 2024

(30) Foreign Application Priority Data
Mar. 30, 2022 (JP) 2022-055888

(51) Int. Cl. H04L 67/12; B60R 16/023; H04L 12/40

(52) U.S. Cl. CPC H04L 67/12; B60R 16/0231; H04L 12/40032; H04L 2012/40215; H04L 2012/40273

(57) ABSTRACT

An information processing method in a management device includes the steps of: creating setting information corresponding to a selected function and related to an in-vehicle component; and transmitting the created setting information to a vehicle in which the in-vehicle component is installed.

### CROSS REFERENCE TO RELATED APPLICATIONS

This application is the U.S. national stage of PCT/JP2023/009536 filed on Mar. 13, 2023, which claims priority of Japanese Patent Application 2022-055888 filed on Mar. 30, 2022, the contents of which are incorporated herein.

### TECHNICAL FIELD

The present disclosure relates to an information processing method, a communication system, and an information processing program.

### BACKGROUND

A vehicle control device such as the following is disclosed in JP 2000-229546A. Specifically, the vehicle control device includes a central ECU 1 that performs overall management of operation of the vehicle, terminal ECUs 2a, 2b, to 2n that control operation of respective units of the vehicle, and an in-vehicle LAN 3 that connects these ECUs to each other; the central ECU obtains vehicle information indicating vehicle specifications from information on terminals that are selectively short-circuited by a vehicle information cartridge 8, which is constituted by a conductive component and mounted to a connector unit 7, provides the obtained information to the terminal ECUs, and sets the type of function to be realized in each of the terminal ECUs in accordance with the vehicle information. The vehicle specifications are managed by the vehicle information cartridge.

Conventionally, technologies related to an in-vehicle network that includes a plurality of in-vehicle electronic control units (ECUs) have been developed.

Conventionally, in-vehicle ECUs for executing various vehicle-related functions have been set individually before vehicle shipment. For this reason, if a function to be provided needs to be changed or the like after vehicle shipment, settings have needed to be changed individually in each vehicle at the dealer or the like.

As described above, with the vehicle control device described in Patent Document 1, by using the vehicle information cartridge, functions and control characteristics that correspond to the vehicle specifications can be set in each in-vehicle ECU. However, in the case where the settings of an in-vehicle ECU are to be changed or an in-vehicle ECU is to be added, the vehicle information cartridge needs be changed, or an additional vehicle information cartridge needs to be added, which poses a problem of not being able to make such accommodations in a flexible manner.

The present disclosure has been made to solve the above-mentioned problems, and an object of the present disclosure is to provide an information processing method, a communication system, and an information processing program that can easily accommodate an addition, change, or the like of a vehicle-related function.

### SUMMARY

An information processing method according to the present disclosure is an information processing method in a management device, including the steps of creating setting information corresponding to a selected function and related to an in-vehicle component; and transmitting the created setting information to a vehicle in which the in-vehicle component is installed.

A communication system according to the present disclosure including: a management device configured to create setting information corresponding to a selected function and related to an in-vehicle component, and transmit the created setting information to a vehicle in which the in-vehicle component is installed; and an in-vehicle device configured to be installed in the vehicle, receive the setting information transmitted by the management device, and perform setting processing for the in-vehicle component based on the received setting information.

An information processing program according to the present disclosure is an information processing program for use in a management device, the information processing program causing a computer to function as: a creation unit configured to create setting information corresponding to a selected function and related to an in-vehicle component; and a communication unit configured to transmit the setting information created by the creation unit to a vehicle in which the in-vehicle component is installed.

One aspect of the present disclosure can be realized not only as an information processing method for carrying out such characteristic processing as steps, but also as a management device that performs such characteristic processing. Also, one aspect of the present disclosure can be realized as a semiconductor integrated circuit that realizes a part or the entirety of the management device.

One aspect of the present disclosure can be realized not only as a communication system that includes such characteristic processing units, but also as a method for carrying out such characteristic processing as steps, or as a program for enabling a computer to carry out such steps. Also, one aspect of the present disclosure can be realized as a semiconductor integrated circuit that realizes a part or the entirety of the communication system.

With the present disclosure, it is possible to easily accommodate an addition, change, or the like of a vehicle-related function.

### BRIEF DESCRIPTION OF THE DRAWINGS

FIG. 1 is a diagram illustrating the configuration of a communication system according to an embodiment of the present disclosure.

FIG. 2 is a diagram illustrating the configuration of the management device according to the embodiment of the present disclosure.

FIG. 3 is a diagram illustrating an example of correspondence information stored in the storage unit in the management device according to the embodiment of the present disclosure.

FIG. 4 is a diagram illustrating an example of correspondence information stored in the storage unit in the management device according to the embodiment of the present disclosure.

FIG. 5 is a diagram illustrating an example of the configuration of the in-vehicle device according to the embodiment of the present disclosure.

FIG. 6 is a diagram illustrating an example of correspondence information stored in the storage unit in the management device according to the embodiment of the present disclosure.

FIG. 7 is a diagram illustrating an example of a history of vehicle information stored in the storage unit in the management device according to the embodiment of the present disclosure.

FIG. 8 is a diagram showing an example of a sequence in the communication system when the in-vehicle device according to the embodiment of the present disclosure is started up in a state in which no setting information is stored.

FIG. 9 is a diagram showing an example of a sequence in the communication system when the in-vehicle device according to the embodiment of the present disclosure is started up in the state where setting information is stored.

### DETAILED DESCRIPTION OF PREFERRED EMBODIMENTS

First, the details of an embodiment of the present disclosure are listed and described.

An information processing method according to an embodiment of the present disclosure is an information processing method in a management device, including the steps of creating setting information corresponding to a selected function and related to an in-vehicle component; and transmitting the created setting information to a vehicle in which the in-vehicle component is installed.

With such a configuration, even after a vehicle is shipped, setting for the vehicle to accommodate a function can be easily performed in the in-vehicle device or the like. Also, even in the case where an in-vehicle device is added to a vehicle after the vehicle is shipped, setting for accommodating a function can be easily performed in the added in-vehicle device similarly to the case of an in-vehicle device installed in the vehicle before shipment. Therefore, it is possible to easily accommodate an addition, change, or the like of a vehicle-related function.

A configuration is possible in which, in the step of creating the setting information, the setting information is created for at least one of each vehicle model and each vehicle year.

According to this configuration, setting for accommodating a function to be realized does not need to be performed for each vehicle model or vehicle year before vehicle shipment, and common settings can be set in vehicles of different vehicle models or vehicle years, thereby making it possible to suppress an increase in part numbers and also simplify setting and management.

A configuration is possible in which, the setting information is used in setting performed so that vehicle information regarding the vehicle is transmitted from the vehicle to the management device.

According to this configuration, vehicle information for executing a function can be collected from the vehicle that is the transmission destination of the setting information, and various functions can be realized using the collected vehicle information.

A configuration is possible in which, the vehicle information includes information regarding traveling of the vehicle.

According to this configuration, it is possible to realize a function such as travel management performed using data related to vehicle travel.

A configuration is possible in which, the vehicle information includes information indicating a measurement result obtained in the vehicle.

According to this configuration, it is possible to realize a function such as travel environment assessment performed using a measurement result obtained by a sensor or the like in the vehicle.

A configuration is possible in which, the setting information includes data position information used to specify the vehicle information in a frame transmitted or received in the vehicle.

The position where vehicle information is stored in a frame may vary depending on the vehicle model and vehicle year, for example, but according to a configuration in which data position information is created in the management device, there is no need to, for example, create different application software for each vehicle as in the case of a configuration in which data position information is registered in advance in the vehicle, thus making it possible to improve flexibility in system construction. Also, since the vehicle information that is to be transmitted can be extracted from a frame and transmitted to the management device, it is possible to reduce the amount of information that is transmitted from the vehicle to the outside.

A configuration is possible in which, the setting information includes transmission timing information indicating a timing at which the vehicle information is to be transmitted to the management device.

The optimal transmission timing for transmitting vehicle information is thought to vary depending on the function to be realized, but according a configuration in which transmission timing information is created in the management device as described above, there is no need to, for example, create different application software for each vehicle as in the case of a configuration in which transmission timing information is registered in advance in the vehicle, thus making it possible to improve flexibility in system construction.

A configuration is possible in which, the management device stores correspondence information indicating a correspondence relationship between a plurality of functions and pieces of the setting information, and in the step of creating the setting information, the correspondence information is referred to, and the piece of setting information corresponding to the selected function is acquired.

According to this configuration, it is possible to easily create setting information that corresponds to the function selected from among various functions.

A configuration is possible in which, the information processing method further includes the step of: creating provision information to be used in executing the selected function, based on vehicle information regarding the vehicle, the vehicle information being received from the vehicle.

According to this configuration, it is possible to create provision information to be used for executing the selected function, while also flexibly accommodating an addition, change, or the like of a function performed using vehicle information.

A configuration is possible in which, the management device is a cloud server.

According to this configuration, setting information can be created and transmitted easily and with a low cost.

A communication system according to an embodiment of the present disclosure including: a management device configured to create setting information corresponding to a selected function and related to an in-vehicle component, and transmit the created setting information to a vehicle in which the in-vehicle component is installed; and an in-vehicle device configured to be installed in the vehicle, receive the setting information transmitted by the management device, and perform setting processing for the in-vehicle component based on the received setting information.

With such a configuration, even after a vehicle is shipped, setting for the vehicle to accommodate a function can be easily performed in the in-vehicle device or the like. Also, even in the case where an in-vehicle device is added to a vehicle after the vehicle is shipped, setting for accommodating a function can be easily performed in the added in-vehicle device similarly to the case of an in-vehicle device installed in the vehicle before shipment. Therefore, it is possible to easily accommodate an addition, change, or the like of a vehicle-related function.

An information processing program according to an embodiment of the present disclosure is an information processing program for use in a management device, the information processing program causing a computer to function as: a creation unit configured to create setting information corresponding to a selected function and related to an in-vehicle component; and a communication unit configured to transmit the setting information created by the creation unit to a vehicle in which the in-vehicle component is installed.

With such a configuration, even after a vehicle is shipped, setting for the vehicle to accommodate a function can be easily performed in the in-vehicle device or the like. Also, even in the case where an in-vehicle device is added to a vehicle after the vehicle is shipped, setting for accommodating a function can be easily performed in the added in-vehicle device similarly to the case of an in-vehicle device installed in the vehicle before shipment. Therefore, it is possible to easily accommodate an addition, change, or the like of a vehicle-related function.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Overall Configuration

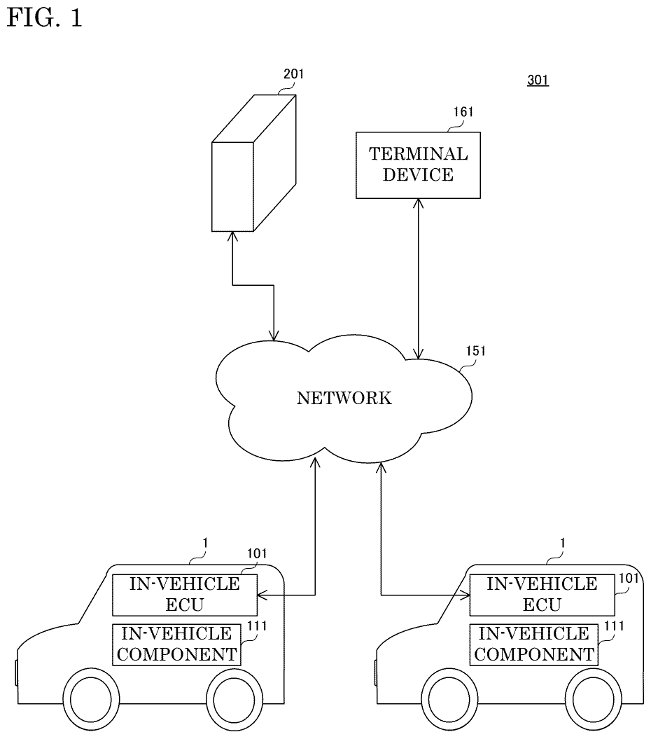

FIG. 1 is a diagram illustrating the configuration of a communication system according to an embodiment of the present disclosure. As shown in FIG. 1, a communication system 301 includes one or more in-vehicle ECUs (in-vehicle devices) 101, a terminal device 161, and a management device 201. The in-vehicle ECUs 101, the terminal device 161, and the management device 201 can transmit and receive information via a network 151 such as the Internet. The in-vehicle ECUs 101 are installed together with in-vehicle components 111 in vehicles 1.

The management device 201 is managed by, for example, a business operator that provides a function related to the vehicle 1. The terminal device 161 is managed by, for example, a business operator or an individual who carries out the function related to the vehicle 1 (hereinafter, collectively referred to as “the user”). Specifically, one example of a function related to the vehicle 1 is a function for managing the traveling history of the vehicle 1.

The management device 201 collects, from the one or more in-vehicle ECUs 101, vehicle information regarding the corresponding vehicle 1. The management device 201 also creates provision information used for executing the aforementioned function selected by the user, based on one or more pieces of the collected vehicle information. The vehicle information includes, for example, information regarding the traveling of the vehicle 1.

Specifically, the management device 201 collects, for example, position information and vehicle speed information regarding each of a plurality of vehicles 1, and based on the collected position information and vehicle speed information, creates provision information such as map information in which the traveling positions of the vehicles 1 are mapped on a map in a display mode corresponding to the vehicle speeds. A business operator (user) can use the provision information to manage the driving of the vehicles 1, for example.

Note that the vehicle information is not limited to position information or vehicle speed information, and may be, for example, brake information indicating a brake state. Also, the vehicle information is not limited to information regarding the traveling of the vehicle 1, and may also be information indicating measurement results obtained in the vehicle 1, specifically, information indicating a measurement result obtained by an in-vehicle component 111 such as a sensor in the vehicle 1, such as image information showing an image of the surroundings of the vehicle 1, the door open/closed status, and temperature information. The vehicle information may also be, for example, identification information of the vehicle 1 or network configuration information of the vehicle 1.

### Configuration of Management Device

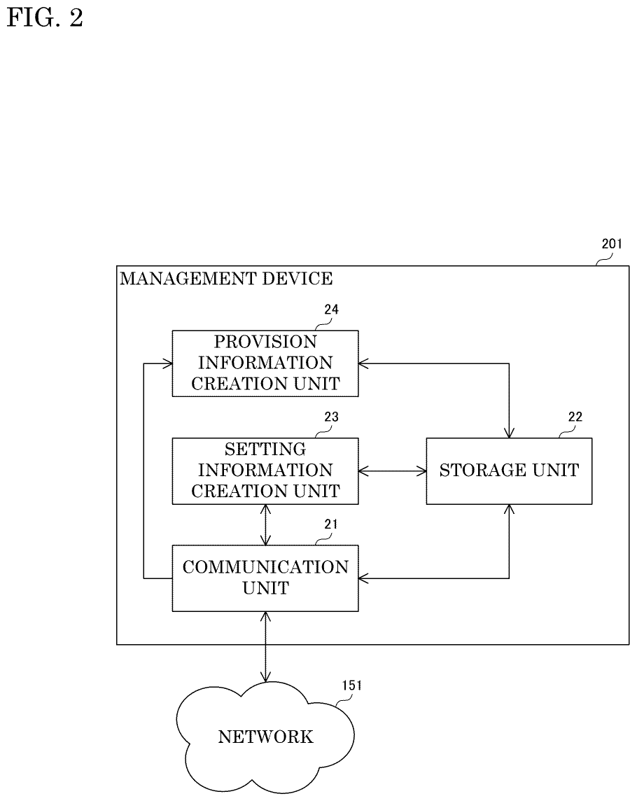

FIG. 2 is a diagram illustrating the configuration of the management device according to the embodiment of the present disclosure. As shown in FIG. 2, the management device 201 includes a communication unit 21, a storage unit 22, a setting information creation unit 23, and a provision information creation unit 24. One or more of the communication unit 21, the setting information creation unit 23, and the provision information creation unit 24 are realized by a processor such as a central processing unit (CPU) or a digital signal processor (DSP). The storage unit 22 is, for example, a non-volatile memory.

The communication unit 21 transmits and receives information to and from the in-vehicle ECUs 101 and the terminal device 161 via the network 151.

The storage unit 22 stores correspondence information indicating the correspondence between functions that can be executed by the user and setting information to be set in the vehicle 1. The setting information is, for example, information used to perform setting so that vehicle information regarding the vehicle 1 is transmitted from the vehicle 1 to the management device 201. In other words, the setting information is information related to setting to be performed in the vehicle 1 in order to acquire, from the vehicle 1, vehicle information used to create provision information.

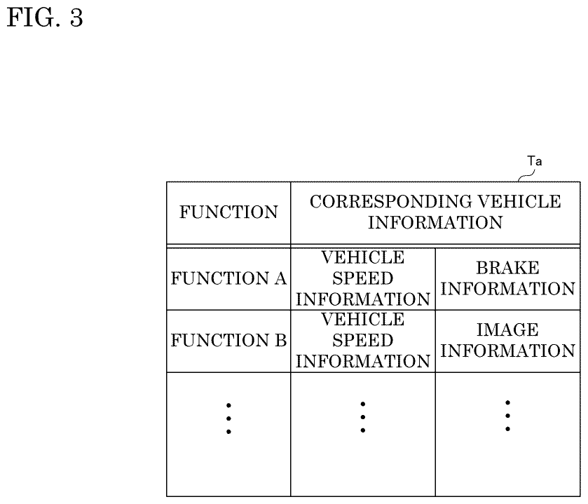

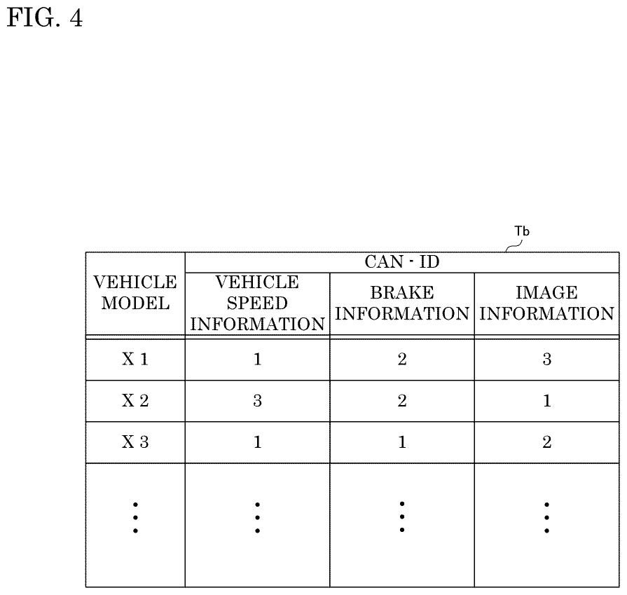

FIGS. 3 and 4 are each a diagram illustrating an example of correspondence information stored in the storage unit in the management device according to the embodiment of the present disclosure. As shown in FIG. 3, the storage unit 22 stores, for example, a correspondence table Ta indicating the correspondence between functions and vehicle information.

Specifically, vehicle speed information and brake information are used to create provision information regarding a function A. Also, vehicle speed information and image information are used to create provision information regarding a function B.

When a new function is added, or when an existing function is changed, for example, the correspondence table Ta is updated by the user, for example.

As shown in FIG. 4, in addition to the correspondence table Ta, the storage unit 22 also stores a correspondence table Tb indicating identification information (hereinafter also referred to as storage ID) identifying the frames in which vehicle information regarding the in-vehicle components 111 is stored, for each vehicle model. The vehicle model is set, for example, according to the use and destination of the vehicle 1.

Here, in the vehicle 1, the vehicle information acquired by the in-vehicle components 111 is transmitted and received according to, for example, the controller area network (CAN (registered trademark)) standard. In this case, the vehicle information is stored in a CAN frame identified by a CAN-ID (Identifier) indicating the type of data, or the like. The CAN frame may be a frame conforming to the classic CAN standard or a frame conforming to the CAN With Flexible Data Rate (CAN FD) standard.

Specifically, in the case of a vehicle 1 of a vehicle model X1, the storage ID for vehicle speed information is CAN-ID “1”, the storage ID for brake information is CAN-ID “2”, and the storage ID for image information is CAN-ID “3”. In the case of a vehicle 1 of a vehicle model X2, the storage ID for vehicle speed information is CAN-ID “3”, the storage ID for brake information is CAN-ID “2”, and the storage ID for image information is CAN-ID “1”. In the case of a vehicle 1 of a vehicle model X3, the storage ID for vehicle speed information is CAN-ID “1”, the storage ID for brake information is CAN-ID “1”, and the storage ID for image information is CAN-ID “2”. In this example, in the vehicle 1 of the vehicle model X3, vehicle speed information and brake information are stored in CAN frames that have the same CAN-ID.

Note that storage unit 22 is not limited to a configuration storing the correspondence table Ta and the correspondence table Tb as correspondence information, and may store, for example, a table in which the content of the correspondence table Ta and the content of the correspondence table Tb are combined in one table.

Returning to FIG. 2, the setting information creation unit 23 creates setting information corresponding to a selected function and related to the in-vehicle component 111.

More specifically, assume the case where the user operates the terminal device 161 to newly select a function. In this case, the terminal device 161 transmits selection information indicating the user selection result to the management device 201 via the network 151.

In the management device 201, for example, the communication unit 21 accepts the selection of the function by the user and outputs selection information indicating the selection result to the setting information creation unit 23. In other words, the communication unit 21 receives the selection information transmitted by the terminal device 161 via the network 151, and outputs the received selection information to the setting information creation unit 23.

The setting information creation unit 23 stores the selection information received from the communication unit 21 in the storage unit 22. Furthermore, the setting information creation unit 23 refers to the above-mentioned correspondence information to acquire the setting information that corresponds to the selected function. The setting information indicates, for example, the types of vehicle information data that are to be used to execute the function. More specifically, the setting information creation unit 23 creates setting information based on the correspondence table Ta and the correspondence table Tb. For example, assume here that the selection information indicates “function A.” In this case, the setting information creation unit 23 refers to the correspondence table Ta and determines that the vehicle information that corresponds to the function A is vehicle speed information and brake information.

The setting information creation unit 23 then refers to the correspondence table Tb and creates setting information for each vehicle model. The setting information creation unit 23 creates setting information indicating the CAN-ID “1”, which corresponds to vehicle speed information, and the CAN-ID “2”, which corresponds to brake information, as setting information to be transmitted to a vehicle 1 of the vehicle model X1. The setting information creation unit 23 then outputs the created setting information corresponding to the vehicle model X1 to the communication unit 21. The communication unit 21 transmits the setting information created by the setting information creation unit 23 to one or more vehicles 1 of the vehicle model X1 via the network 151.

Furthermore, the setting information creation unit 23 creates setting information indicating the CAN-ID “3”, which corresponds to vehicle speed information, and the CAN-ID “2”, which corresponds to brake information, as setting information to be transmitted to a vehicle 1 of the vehicle model X2. The setting information creation unit 23 then outputs the created setting information corresponding to the vehicle model X2 to the communication unit 21. The communication unit 21 transmits the setting information created by the setting information creation unit 23 to one or more vehicles 1 of the vehicle model X2 via the network 151.

The setting information creation unit 23 creates setting information indicating the CAN-ID “1”, which corresponds to vehicle speed information, and the CAN-ID “1”, which corresponds to brake information, as setting information to be transmitted to the vehicle 1 of the vehicle model X3. The setting information creation unit 23 then outputs the created setting information corresponding to the vehicle model X3 to the communication unit 21. The communication unit 21 transmits the setting information created by the setting information creation unit 23 to one or more vehicles 1 of the vehicle model X3 via the network 151.

Note that the correspondence table Tb may indicate storage IDs of pieces of vehicle information for only one vehicle model. In other words, the setting information creation unit 23 may be configured to create setting information for only one vehicle model.

In the vehicle 1, the in-vehicle ECU 101 receives the setting information transmitted by the management device 201, and performs setting processing in the in-vehicle component 111 of the vehicle 1 based on the received setting information. In other words, the in-vehicle ECU 101 performs setting processing so that pieces of vehicle information that correspond to the CAN-IDs indicated in the received setting information are transmitted to the management device 201. The setting processing performed by the in-vehicle ECU 101 will be described in detail later.

In the management device 201, upon receiving vehicle information transmitted by an in-vehicle ECU 101 via the network 151 after the setting processing, the communication unit 21 outputs the received vehicle information to the provision information creation unit 24. The provision information creation unit 24 creates provision information based on the vehicle information received from the communication unit 21.

More specifically, assume here that the provision information creation unit 24 refers to the selection information stored in the storage unit 22 and determines that the function A was selected by the user. Also assume here that the provision information creation unit 24 receives vehicle speed information and brake information from the communication unit 21 as vehicle information. In this case, the provision information creation unit 24 uses the vehicle speed information and the brake information received from the communication unit 21 to create provision information to be used when the function A is executed. The provision information creation unit 24 stores the created provision information in the storage unit 22.

For example, when executing the function A, the user operates the terminal device 161 to request provision information that corresponds to the function A from the management device 201. Upon receiving the request for provision information from the terminal device 161, the communication unit 21 of the management device 201, for example, acquires the provision information that corresponds to the function A stored in the storage unit 22, and transmits the acquired provision information to the terminal device 161 via the network 151. Accordingly, the user can execute the function A using the provision information created by the management device 201.

Note that the setting information is not limited to information used to perform setting for transmitting vehicle information from the vehicle 1 to the management device 201, and may be information used to perform some sort of other setting, such as operation setting for causing an in-vehicle component 111 to execute a selected function.

Furthermore, a configuration is possible in which the storage unit 22 does not store the correspondence information. In this case, the setting information creation unit 23 creates setting information by performing some sort of other calculation processing without using the correspondence information.

Also, a device other than the management device 201 may be configured to create the provision information. In this case, the management device 201 transmits the vehicle information received from the vehicle 1 to the other device.

Furthermore, the user may, for example, directly input the selection target function to the management device 201 without using the terminal device 161. In this case, the communication system 301 does not need to include the terminal device 161.

Furthermore, the management device 201 is not limited to being configured to acquire the result of a function selection performed by a user, and may be configured to automatically select a function based on some sort of information, for example.

### Configuration of In-Vehicle Device

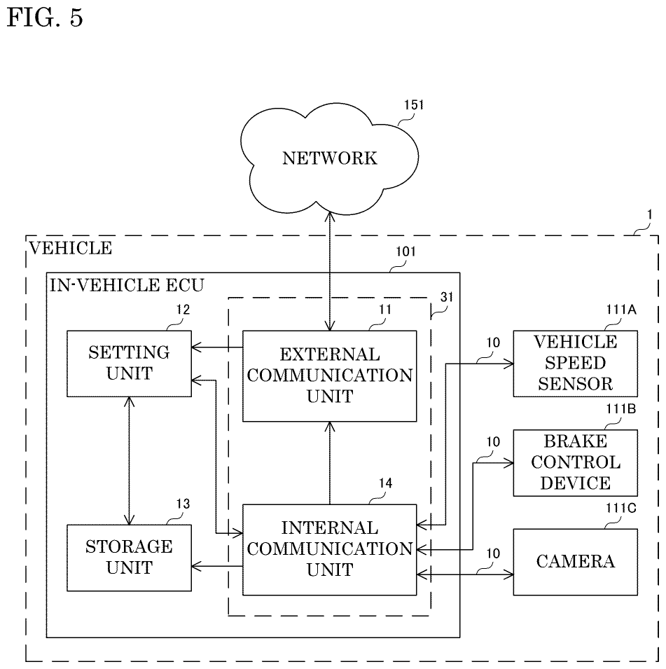

FIG. 5 is a diagram illustrating an example of the configuration of the in-vehicle device according to the embodiment of the present disclosure. As shown in FIG. 5, the in-vehicle ECU 101 is an example of an in-vehicle device, and is connected to a plurality of in-vehicle components 111 via a CAN bus 10, for example, and is capable of communicating with the in-vehicle components 111 connected thereto. The in-vehicle ECU 101 includes a setting unit 12, a storage unit 13, and a communication unit 31. The communication unit 31 includes an external communication unit 11 and an internal communication unit 14. One or more of the external communication unit 11, the setting unit 12, and the internal communication unit 14 are realized by a processor such as a CPU or a DSP. The storage unit 13 is, for example, a non-volatile memory.

The external communication unit 11 communicates with the management device 201 via the network 151 by performing wireless communication with a wireless base station (not shown) in accordance with a communication method such as WiFi (registered trademark), LTE (Long Term Evolution), or 5G. For example, the external communication unit 11 receives setting information transmitted by the management device 201 via the network 151 and outputs the received setting information to the setting unit 12. Note that the external communication unit 11 is not limited to being configured to perform communication with the management device 201 via a wireless base station and the network 151, and may be configured to perform communication with the management device 201 via a wired line. Furthermore, the external communication unit 11 may be configured to perform communication with the management device 201 via another in-vehicle ECU 101.

The internal communication unit 14 performs communication with the in-vehicle components 111 in accordance with the CAN standard. For example, the internal communication unit 14 performs processing for receiving vehicle speed information transmitted by a vehicle speed sensor 111A and brake information transmitted by a brake control device 111B, and relaying the received vehicle speed information and brake information to an autonomous driving ECU (not shown). Also, the internal communication unit 14 performs processing for receiving image information transmitted by a camera 111C and storing the received image information in the storage unit 13, for example.

Note that the in-vehicle ECU 101 and the in-vehicle components 111 are not limited to being configured to transmit and receive CAN frames, and may be configured to perform communication in accordance with a standard such as Local Interconnect Network (LIN), Clock Extension Peripheral Interface (CXPI), Ethernet (registered trademark), or Universal Serial Bus (USB). Also, the in-vehicle ECU 101 and the in-vehicle components 111 may be configured to perform wireless communication in accordance with a standard such as Bluetooth (registered trademark).

In this way, in the case where communication conforming to a standard other than CAN is performed between the in-vehicle ECU 101 and the in-vehicle components 111, the setting information transmitted by the management device 201 to the in-vehicle ECU 101 includes, for example, a storage ID other than a CAN-ID.

The setting unit 12 receives the setting information output by the external communication unit 11, stores the setting information in the storage unit 13, and performs setting processing for the in-vehicle components 111 based on the setting information. For example, the setting unit 12 uses the setting information to perform setting so that vehicle information regarding the vehicle 1 is transmitted from the vehicle 1 to the management device 201. Specifically, as the setting processing, the setting unit 12 performs setting so that vehicle information corresponding to the type of data indicated by the setting information is transmitted to the management device 201.

For example, in the case of the vehicle 1 of the vehicle model X1, upon receiving setting information indicating the CAN-ID “1”, the setting unit 12 performs, as the setting processing, setting for the vehicle speed sensor 111A or the in-vehicle ECU 101 so that vehicle information having the CAN-ID “1” (i.e., vehicle speed information) is transmitted to the management device 201.

More specifically, in the case where the internal communication unit 14 periodically or irregularly receives vehicle speed information transmitted by the vehicle speed sensor 111A, the setting unit 12 performs setting in the internal communication unit 14 so as to output the received vehicle speed information to the external communication unit 11. Also, the setting unit 12 performs setting in the external communication unit 11 so as to transmit the vehicle speed information received from the internal communication unit 14 to the management device 201.

On the other hand, in the case of a situation in which vehicle speed information is not transmitted by the vehicle speed sensor 111A to the internal communication unit 14, as the setting processing, the setting unit 12 requests the vehicle speed sensor 111A to transmit vehicle speed information via the internal communication unit 14. Upon receiving the request from the in-vehicle ECU 101, the vehicle speed sensor 111A periodically or irregularly transmits vehicle speed information to the in-vehicle ECU 101. Also, the setting unit 12 performs setting in the internal communication unit 14 so as to output the received vehicle speed information to the external communication unit 11. Also, the setting unit 12 performs setting in the external communication unit 11 so as to transmit the vehicle speed information received from the internal communication unit 14 to the management device 201.

By carrying out such setting processing, vehicle speed information regarding the vehicle 1 indicated by the setting information is transmitted to the management device 201.

### Data Position Information and Transmission Timing Information

The setting information may include data position information used to identify a piece of vehicle information in a frame transmitted and received by the vehicle 1. Specifically, the internal communication unit 14 may be configured to, in accordance with the setting processing performed by the setting unit 12, acquire vehicle information from a CAN frame based on data position information included in the setting information, and transmit the vehicle information to the management device 201.

Also, the setting information may include transmission timing information that indicates the timing of transmission of vehicle information to the management device 201. Specifically, the internal communication unit 14 may be configured to, in accordance with the setting processing performed by the setting unit 12, transmit vehicle information to the management device 201 at a transmission timing indicated by the transmission timing information included in the setting information and indicating a timing at which vehicle information is to be transmitted to the management device 201.

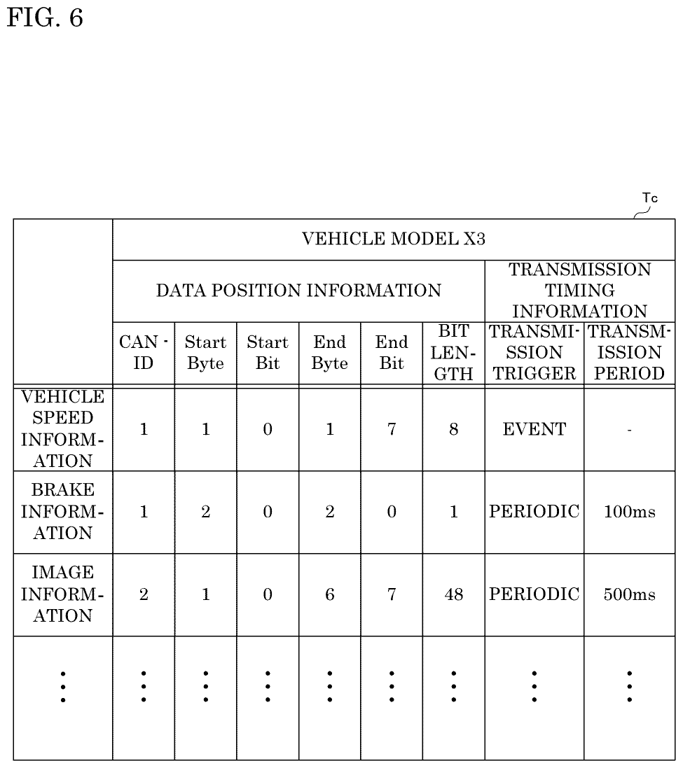

FIG. 6 is a diagram illustrating an example of correspondence information stored in the storage unit in the management device according to the embodiment of the present disclosure. As shown in FIG. 6, in addition to the correspondence table Ta and the correspondence table Tb, the storage unit 22 may store a correspondence table Tc indicating data position information and transmission timing information for each vehicle model. FIG. 6 shows a representative example of data position information and transmission timing information for the vehicle model X3.

For each piece of vehicle information, the data position information indicates a CAN-ID, which is the storage ID of the piece of vehicle information, and the position of the piece of vehicle information in the CAN frame. The transmission timing information indicates the timing at which the piece of vehicle information is to be transmitted to the management device 201.

Specifically, the correspondence table Tc indicates the correspondence between a type of vehicle information, a storage ID, byte positions and bit positions that are the starting point and the ending point of the vehicle information in the payload of a CAN frame, a bit length, a transmission trigger, and a transmission period.

In the example shown in FIG. 6, in the vehicle 1 of the vehicle model X3, the vehicle speed information is 8-bit data extending from the 0-th bit of the first byte to the 7-th bit of the first byte in the payload of the CAN frame with the CAN-ID “1”. Furthermore, the occurrence of an event, such as the timing when the internal communication unit 14 receives vehicle information, is the transmission timing when the vehicle speed information is to be transmitted by the vehicle 1 to the management device 201. Also, the brake information is 1-bit data extending from the 0-th bit of the second byte to the 0-th bit of the second byte in the payload of the CAN frame with the CAN-ID “1”. The transmission timing of the brake information is a periodic timing of 100 milliseconds. Also, the image information is 48-bit data extending from the 0-th bit of the first byte to the 7-th bit of the sixth byte in the payload of the CAN frame with the CAN-ID “2”. The transmission timing of the image information is a periodic timing of 500 milliseconds.

In the management device 201, the setting information creation unit 23 creates setting information based on the correspondence tables Ta, Tb, and Tc. For example, assume here that the selection information indicates “function B”. In this case, the setting information creation unit 23 refers to the correspondence table Ta and determines that the vehicle information that corresponds to the function B is vehicle speed information and image information.

The setting information creation unit 23 also refers to the correspondence table Tb and creates setting information for each vehicle model. For example, as the setting information to be transmitted to a vehicle 1 of the vehicle model X3, the setting information creation unit 23 creates setting information indicating the CAN-ID “1”, which corresponds to the vehicle speed information, and the CAN-ID “2”, which corresponds to the image information.

The setting information creation unit 23 also refers to the correspondence table Tc and creates, as the setting information to be transmitted to the vehicle 1 of the vehicle model X3, setting information further indicating the start point, the end point, the transmission trigger, and the transmission period of each piece of vehicle information corresponding to the vehicle speed information and image information.

The setting information creation unit 23 outputs the created setting information corresponding to the vehicle model X3 and the function B to the communication unit 21. The communication unit 21 transmits the setting information created by the setting information creation unit 23 to one or more vehicles 1 of the vehicle model X3 via the network 151.

In the in-vehicle ECU 101, the external communication unit 11 receives the setting information transmitted by the management device 201 via the network 151, and outputs the received setting information to the setting unit 12.

The setting unit 12 receives the setting information output from the external communication unit 11 and, based on the setting information, performs setting processing for the in-vehicle component 111 so that pieces of vehicle information that correspond to the specified data types are transmitted to the management device 201 at the specified timings.

More specifically, as the setting processing, the setting unit 12 performs setting in the internal communication unit 14, the external communication unit 11, the vehicle speed sensor 111A, and the like so that vehicle speed information is extracted from the positions indicated by the setting information in the payload of the CAN frame with the CAN-ID “1” and transmitted to the management device 201 at the transmission timing indicated by the setting information. Also, as the setting processing, the setting unit 12 performs setting in the internal communication unit 14, the external communication unit 11, the camera 111C, and the like so that image information is extracted from the positions indicated by the setting information in the payload of the CAN frame with the CAN-ID “3” and transmitted to the management device 201 at the transmission timing indicated by the setting information.

The internal communication unit 14 extracts vehicle information at the positions set by the setting unit 12 from the CAN frame with the CAN-ID set by the setting unit 12. In the case where the transmission trigger for the vehicle information is the occurrence of an event, the internal communication unit 14 outputs the vehicle information to the external communication unit 11 in response to receiving vehicle information from the in-vehicle component 111. On the other hand, in the case where the transmission trigger for the vehicle information is a periodic timing, the internal communication unit 14 stores pieces of vehicle information in the storage unit 13 each time the pieces of vehicle information are received from the in-vehicle component 111, and acquires one or more pieces of stored vehicle information from the storage unit 13 at the periodic timing and outputs the acquired pieces of vehicle information to the external communication unit 11.

In this manner, with a configuration in which the correspondence table Tc is stored in the management device 201 and used to create setting information, even after the in-vehicle ECU 101 is installed in a vehicle 1, it is possible to extract and transmit vehicle information upon receiving setting information from the management device 201. Accordingly, it is possible to ease restrictions on the models of vehicle in which the in-vehicle ECU 101 can be installed, and also increase the degree of freedom in the targets in which the in-vehicle ECU 101 can be installed. Furthermore, vehicle information can be acquired from each vehicle 1 in units of vehicle information rather than units of CAN frame, thus eliminating the need for different vehicle information processing application software for each vehicle model to be installed in the management device 201, and making it possible to perform such processing with, for example, one type of application software.

Note that the correspondence table Tc may indicate only either the data position information or the transmission timing information.

Furthermore, the management device 201 may be configured to not hold the correspondence table Tc. In this case, for example, the in-vehicle ECU 101 refers to data position information and transmission timing information registered in advance in the storage unit 13, and extracts and transmits specified vehicle information from a specified CAN frame.

Furthermore, the above-described “for each vehicle model” may be replaced with “for each vehicle year” or “for each combination of vehicle model and vehicle year”. In other words, the setting unit 12 creates setting information for at least one of each vehicle model and each vehicle year. Here, “vehicle year” means the year the vehicle was manufactured.

Also, the in-vehicle ECU 101 is not limited to being configured to extract vehicle information from a CAN frame, and may be configured to transmit a CAN frame that includes vehicle information to the management device 201.

### History Information Regarding Vehicle Information

In the management device 201, the provision information creation unit 24 may be configured to create history information regarding vehicle information received from the communication unit 21 and store the history information in the storage unit 22.

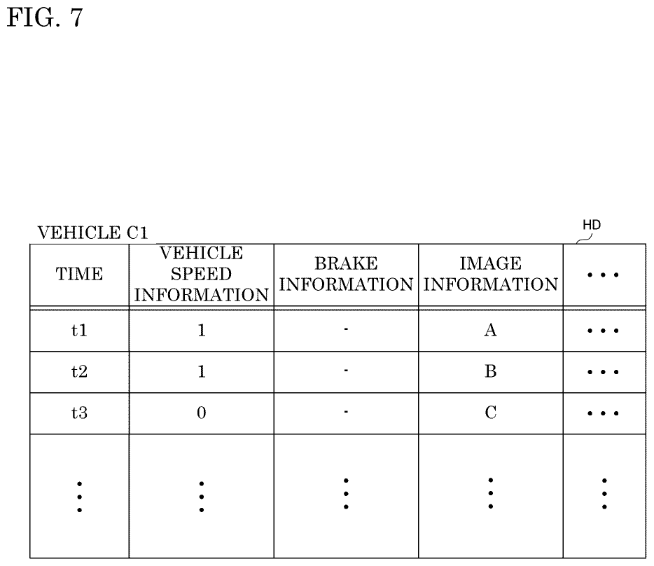

FIG. 7 is a diagram illustrating an example of a history of vehicle information stored in the storage unit in the management device according to the embodiment of the present disclosure. As shown in FIG. 7, for each vehicle 1, the storage unit 22 stores history information HD regarding pieces of vehicle information. FIG. 7 shows the history information HD for a certain vehicle C1.

In the example shown in FIG. 7, at a time t1, the vehicle speed information is “1”, the image information is “A”, and brake information has not been obtained. At a time t2, the vehicle speed information is “1”, the image information is “B”, and brake information has not been obtained. At a time t3, the vehicle speed information is “0”, the image information is “C”, and brake information has not been obtained.

Although the amount of history information HD to be stored in the management device 201 increases as the number of vehicles 1 increases, as described above, with a configuration in which, rather than storing information in units of CAN frames, vehicle information extracted from CAN frames is registered in a database, and thus the amount of data stored in the storage unit 22 can be reduced.

Assume here that the provision information creation unit 24 refers to selection information stored in the storage unit 22 and determines that the function A was selected by the user. The provision information creation unit 24 then refers to the history information HD in the storage unit 22 and creates provision information to be used when the function A is executed. The provision information creation unit 24 stores the created provision information in the storage unit 22.

### Operation Flow

Next, the operation of devices in the communication system according to the embodiment of the present disclosure will be described with reference to the drawings.

The devices in the communication system 301 each have a computer that includes a memory, and in each of such devices, an arithmetic processing unit such as a CPU in the computer reads out, from the memory, a program that includes part or all of the steps of the sequence described below, and executes the program. The programs executed by the devices can be installed from an external source. The programs executed by the devices are distributed in a state of being stored in recording media.

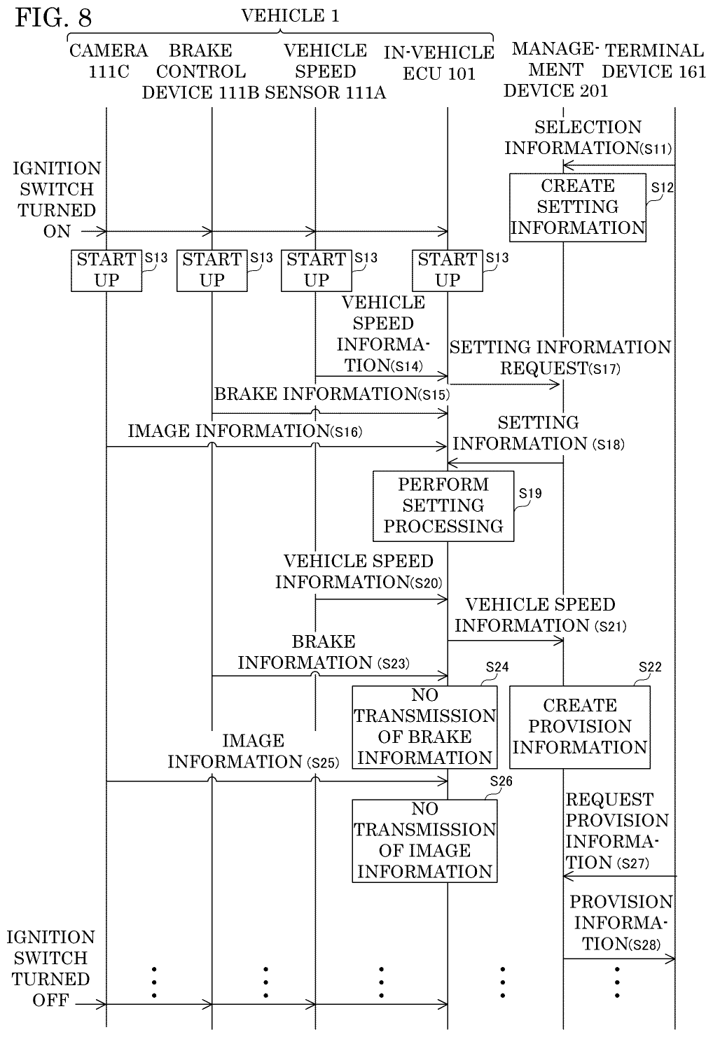

FIG. 8 is a diagram showing an example of a sequence in the communication system when the in-vehicle device according to the embodiment of the present disclosure is started up in a state in which no setting information is stored. The following describes the operation of devices including the in-vehicle ECU 101 and the in-vehicle components 111 in the vehicle 1 of the vehicle model X1, as well as the management device 201, and the terminal device 161. Here, assume that the in-vehicle components 111 are the vehicle speed sensor 111A, the brake control device 111B, and the camera 111C.

As shown in FIG. 8, first, assume that the user operates the terminal device 161 to select the function C. In this case, the terminal device 161 transmits selection information indicating the user selection result to the management device 201 via the network 151 (step S11).

Next, upon receiving the selection information transmitted by the terminal device 161 via the network 151, the management device 201 creates setting information based on the received selection information. Specifically, assume that the management device 201 determines that the vehicle information that corresponds to the function C indicated by the selection information is vehicle speed information. In this case, as setting information corresponding to the vehicle model X1, the management device 201 creates, for example, setting information indicating the CAN-ID “1”, which corresponds to vehicle speed information of the vehicle 1 of the vehicle model X1 (step S12).

Next, for example, when the ignition switch of the vehicle 1 is switched on, the in-vehicle ECU 101, the vehicle speed sensor 111A, the brake control device 111B, and the camera 111C in the vehicle 1 start up (step S13).

Next, the vehicle speed sensor 111A measures the speed of the vehicle 1, stores vehicle speed information indicating the measurement result in a CAN frame with the CAN-ID “1”, and transmits the CAN frame to the in-vehicle ECU 101 (step S14).

Next, the brake control device 111B stores brake information indicating a brake state of the vehicle 1 in a CAN frame with the CAN-ID “2”, and transmits the CAN frame to the in-vehicle ECU 101 (step S15).

Next, the camera 111C captures an image of the surroundings of the vehicle 1, stores image information indicating the captured image of the surroundings in a CAN frame with the CAN-ID “3”, and transmits the CAN frame to the in-vehicle ECU 101 (step S16).

Next, upon receiving vehicle information from, for example, at least the vehicle speed sensor 111A, the brake control device 111B, or the camera 111C, the in-vehicle ECU 101 transmits a setting information request, which is for checking whether setting information has been created, to the management device 201 via the network 151. Here, after receiving the vehicle speed information from the vehicle speed sensor 111A (step S14), the in-vehicle ECU 101 transmits the setting information request to the management device 201 (step S17).

The setting information request includes, for example, identification information of the in-vehicle ECU 101 that is the transmission source, and the vehicle model X1 of the vehicle 1 in which the in-vehicle ECU 101 is installed. Note that the in-vehicle ECU 101 may be configured to transmit the setting information request to the management device 201 before receiving the vehicle speed information from the vehicle speed sensor 111A. In other words, upon being started up, the in-vehicle ECU 101 may transmit the setting information request before the reception of vehicle information. Also, the in-vehicle ECU 101 may be configured to transmit the setting information request periodically or irregularly until the ignition switch of the vehicle 1 is switched from the on state to the off state, for example.

Next, upon receiving the setting information request transmitted by the in-vehicle ECU 101, the management device 201 determines that “X1” is the vehicle model of the vehicle 1 that includes the in-vehicle ECU 101 that is the transmission source of the received setting information request. Furthermore, the management device 201 checks whether or not setting information corresponding to the vehicle model X1 has been created. Here, in step S12, since the management device 201 has created setting information corresponding to the vehicle model X1, the management device 201 transmits the setting information via the network 151 to the in-vehicle ECU 101 that is the transmission source of the setting information request (step S18).

Next, upon receiving the setting information transmitted by the management device 201 via the network 151, the in-vehicle ECU 101 performs setting processing for the in-vehicle component 111 based on the received setting information. Specifically, as the setting processing, the in-vehicle ECU 101 performs setting so that vehicle speed information corresponding to the CAN-ID “1” is transmitted to the management device 201 at the specified timing. After such setting processing is performed, vehicle speed information from the vehicle speed sensor 111A is transmitted to the management device 201. Furthermore, the in-vehicle ECU 101 stores the received setting information in the storage unit 13 (step S19).

Next, the vehicle speed sensor 111A measures the speed of the vehicle 1, stores vehicle speed information indicating the measurement result in a CAN frame with the CAN-ID “1”, and transmits the CAN frame to the in-vehicle ECU 101 (step S20).

Next, upon receiving the vehicle speed information transmitted by the vehicle speed sensor 111A, the in-vehicle ECU 101 transmits the received vehicle speed information to the management device 201 via the network 151 in accordance with the content of the setting processing performed in step S19 (step S21).

Next, upon receiving the vehicle speed information transmitted by the in-vehicle ECU 101 via the network 151, the management device 201 uses the received vehicle speed information to create provision information to be used for executing the function C. The management device 201 stores the created provision information, for example. Note that the management device 201 may be configured to create the history information HD as described above and use the history information HD to create provision information to be used in executing the selected function C (step S22).

Next, the brake control device 111B stores brake information indicating a brake state of the vehicle 1 in a CAN frame with the CAN-ID “2”, and transmits the CAN frame to the in-vehicle ECU 101 (step S23).

Next, the in-vehicle ECU 101 receives the brake information transmitted by the brake control device 111B, but, in accordance with the content of the setting processing performed in step S19, does not transmit the received brake information to the management device 201 (step S24).

Next, the camera 111C captures an image of the surroundings of the vehicle 1, stores image information indicating the captured image of the surroundings in a CAN frame with the CAN-ID “3”, and transmits the CAN frame to the in-vehicle ECU 101 (step S25).

Next, the in-vehicle ECU 101 receives the image information transmitted by the camera 111C, but, in accordance with the content of the setting processing performed in step S19, does not transmit the received image information to the management device 201 (step S26).

Next, upon being operated by the user, the terminal device 161, for example, requests the management device 201 for provision information corresponding to the function C (step S27).

Next, upon receiving the request for provision information from the terminal device 161, the management device 201 transmits stored provision information corresponding to the function C to the terminal device 161 via the network 151 (step S28). Accordingly, the user can execute the function C using the provision information created by the management device 201. Then, until the ignition switch of the vehicle 1 is switched off, for example, operations similar to those of steps S20 to S28 described above are repeatedly performed. For example, when the ignition switch of the vehicle 1 is switched off, the in-vehicle ECU 101, the vehicle speed sensor 111A, the brake control device 111B, and the camera 111C are stopped.

Note that the in-vehicle ECU 101, the vehicle speed sensor 111A, the brake control device 111B, and the camera 111C may be configured to be started up according to a trigger other than the ignition switch being switched to the on state. Furthermore, the in-vehicle ECU 101, the vehicle speed sensor 111A, the brake control device 111B, and the camera 111C may be configured to be stopped according to a trigger other than the ignition switch being switched to the off state.

Also, in the case where the management device 201 receives a setting information request from the in-vehicle ECU 101 (step S17) and has not created corresponding setting information, the management device 201 does not transmit setting information to the in-vehicle ECU 101.

Regarding communication performed within the vehicle 1, for example, initial setting of the in-vehicle ECU 101 performed using a diagnostic tool or the like is performed on the vehicle 1 at the dealer or the like. In this case, even if the in-vehicle ECU 101 has never received any setting information from the management device 201, communication between the in-vehicle component 111 and the in-vehicle ECU 101 can be performed normally.

Note that when initial setting of the in-vehicle ECU 101 is performed at the dealer or the like, setting information corresponding to a function to be executed by the user may be stored in the in-vehicle ECU 101.

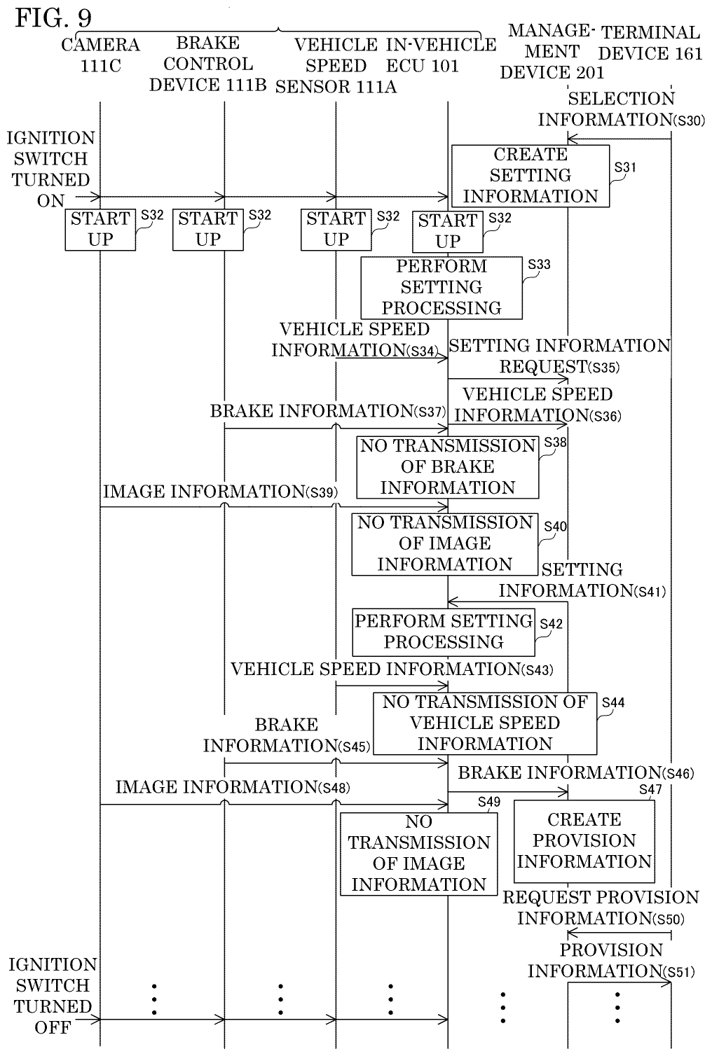

FIG. 9 is a diagram showing an example of a sequence in the communication system when the in-vehicle device according to the embodiment of the present disclosure is started up in the state where setting information is stored. Here, assume that setting processing has already been performed in step S19 shown in FIG. 8 so that vehicle speed information corresponding to the CAN-ID “1” is transmitted to the management device 201.

As shown in FIG. 9, first, assume that the user operates the terminal device 161 to change the selected function from the function C to a function D. In this case, the terminal device 161 transmits selection information indicating the user selection result to the management device 201 via the network 151 (step S30).

Next, upon receiving the selection information transmitted by the terminal device 161 via the network 151, the management device 201 creates setting information based on the received selection information. Specifically, assume that the management device 201 determines that the vehicle information that corresponds to the function D indicated by the selection information is brake information. In this case, as setting information corresponding to the vehicle model X1, the management device 201 creates, for example, setting information indicating the CAN-ID “2”, which corresponds to brake information of the vehicle 1 of the vehicle model X1 (step S31).

Next, for example, when the ignition switch of the vehicle 1 is switched on, the in-vehicle ECU 101, the vehicle speed sensor 111A, the brake control device 111B, and the camera 111C start up (step S32).

Next, the setting unit 12 of the in-vehicle ECU 101 performs setting processing for the in-vehicle component 111 based on the setting information stored in the storage unit 13. Specifically, as the setting processing, the in-vehicle ECU 101 performs setting so that vehicle speed information corresponding to the CAN-ID “1” is transmitted to the management device 201 at the specified timing (step S33).

Next, the vehicle speed sensor 111A measures the speed of the vehicle 1, stores vehicle speed information indicating the measurement result in a CAN frame with the CAN-ID “1”, and transmits the CAN frame to the in-vehicle ECU 101 (step S34).

Next, similarly to step S17 shown in FIG. 8, for example, after receiving the vehicle speed information from the vehicle speed sensor 111A (step S34), the in-vehicle ECU 101 transmits the setting information request to the management device 201 (step S35).

Next, in accordance with the content of the setting processing performed in step S33, the in-vehicle ECU 101 transmits the received vehicle speed information to the management device 201 via the network 151 (step S36). Note that the transmission of the vehicle speed information by the in-vehicle ECU 101 (step S36) may be performed before the transmission of the setting information request by the in-vehicle ECU 101 (step S35).

Next, the brake control device 111B stores brake information indicating a brake state of the vehicle 1 in a CAN frame with the CAN-ID “2”, and transmits the CAN frame to the in-vehicle ECU 101 (step S37).

Next, the in-vehicle ECU 101 receives the brake information transmitted by the brake control device 111B, but, in accordance with the content of the setting processing performed in step S33, does not transmit the received brake information to the management device 201 (step S38).

Next, the camera 111C captures an image of the surroundings of the vehicle 1, stores image information indicating the captured image of the surroundings in a CAN frame with the CAN-ID “3”, and transmits the CAN frame to the in-vehicle ECU 101 (step S39).

Next, the in-vehicle ECU 101 receives the image information transmitted by the camera 111C, but, in accordance with the content of the setting processing performed in step S33, does not transmit the received image information to the management device 201 (step S40).

Next, upon receiving the setting information request transmitted by the in-vehicle ECU 101, the management device 201 determines that “X1” is the vehicle model of the vehicle 1 that includes the in-vehicle ECU 101 that is the transmission source of the received setting information request. The management device 201 also checks whether or not new setting information corresponding to the vehicle model X1 has been created. Here, since new setting information corresponding to the vehicle model X1 was created in step S31, the management device 201 transmits the setting information via the network 151 to the in-vehicle ECU 101 that is the transmission source of the setting information request (step S41).

Note that if new setting information corresponding to the vehicle model X1 has not been created, the management device 201 does not transmit setting information. In this case, in the vehicle 1, the content of the setting processing that has already been performed is maintained. Furthermore, in the case where new setting information corresponding to the vehicle model X1 has not been created, the management device 201 may again transmit setting information that has already been transmitted to the in-vehicle ECU 101.

Next, upon receiving the setting information transmitted by the management device 201 via the network 151, the in-vehicle ECU 101 performs setting processing for the in-vehicle component 111 based on the received setting information. Specifically, the in-vehicle ECU 101 performs setting so that the transmission of vehicle speed information corresponding to the CAN-ID “1” is stopped, and also so that brake information corresponding to the CAN-ID “2” is transmitted to the management device 201 at the specified timing. After such setting processing is performed, brake information from the brake control device 111B is transmitted to the management device 201. Furthermore, the in-vehicle ECU 101 stores the received setting information in the storage unit 13 (step S42).

Next, the vehicle speed sensor 111A measures the speed of the vehicle 1, stores vehicle speed information indicating the measurement result in a CAN frame with the CAN-ID “1”, and transmits the CAN frame to the in-vehicle ECU 101 (step S43).

Next, the in-vehicle ECU 101 receives the vehicle speed information transmitted by the vehicle speed sensor 111A, but, in accordance with the content of the current setting processing performed in step S42, does not transmit the received vehicle speed information to the management device 201 (step S44).

Next, the brake control device 111B stores brake information indicating a brake state of the vehicle 1 in a CAN frame with the CAN-ID “2”, and transmits the CAN frame to the in-vehicle ECU 101 (step S45).

Next, upon receiving the brake information transmitted by the brake control device 111B, in accordance with the current content of the setting processing performed in step S42, the in-vehicle ECU 101 transmits the received brake information to the management device 201 via the network 151 (step S46).

Next, upon receiving the brake information transmitted by the in-vehicle ECU 101 via the network 151, the management device 201 uses the received brake information to create provision information to be used for executing the function D. The management device 201 stores the created provision information, for example. Note that the management device 201 may be configured to create the history information HD as described above and use the history information HD to create provision information to be used in executing the selected function D (step S47).

Next, the camera 111C captures an image of the surroundings of the vehicle 1, stores image information indicating the captured image of the surroundings in a CAN frame with the CAN-ID “3”, and transmits the CAN frame to the in-vehicle ECU 101 (step S48).

Next, the in-vehicle ECU 101 receives the image information transmitted by the camera 111C, but, in accordance with the current content of the setting processing performed in step S42, does not transmit the received image information to the management device 201 (step S49).

Next, upon by being operated by the user, the terminal device 161, for example, requests the management device 201 for provision information corresponding to the function D (step S50).

Next, upon receiving the request for provision information from the terminal device 161, the management device 201 transmits stored provision information that corresponds to the function D to the terminal device 161 via the network 151 (step S51). Accordingly, the user can execute the function D using the provision information created by the management device 201.

Then, until the ignition switch of the vehicle 1 is switched off, for example, operations similar to those of steps S43 to S51 described above are repeatedly performed. Also, if the user makes a further change to the selected function, operations similar to steps S30 and S31 and steps S34 to S51 described above are performed. For example, when the ignition switch of the vehicle 1 is switched off, the in-vehicle ECU 101, the vehicle speed sensor 111A, the brake control device 111B, and the camera 111C are stopped.

Note that there is no limitation to the case of a change to the selected function, and also in the case where a new in-vehicle component 111 is added to the vehicle 1 after the vehicle 1 is shipped, by performing the above-described setting processing on the in-vehicle ECU 101 and the like installed in the vehicle 1, the vehicle 1 can accommodate the function to be executed.

It is conceivable that various vehicle-related functions are executed using vehicle information acquired by the in-vehicle ECU. Conventionally, when setting for the transmission of vehicle information outside of the vehicle is performed in in-vehicle ECUs, such setting has been performed individually according to the vehicle model and the like before vehicle shipment. For this reason, if a change or the like needs to be made to the functions that are to be provided after vehicle shipment, settings have needed to be changed individually in each vehicle at the dealer or the like.

As described above, with the vehicle control device described in Patent Document 1, by using the vehicle information cartridge, functions and control characteristics that correspond to the vehicle specifications can be set in each in-vehicle ECU. However, in the case where the settings of an in-vehicle ECU are to be changed or an in-vehicle ECU is to be added, the vehicle information cartridge needs be changed, or an additional vehicle information cartridge needs to be added, which poses a problem of not being able to make such accommodations in a flexible manner.

In contrast, with the information processing method according to the embodiment of the present disclosure, first, setting information corresponding to a selected function and related to an in-vehicle component 111 is created. Then the created setting information is transmitted to the vehicle 1 that includes the in-vehicle component 111.

According to this configuration, even after the vehicle 1 is shipped, setting for the vehicle 1 to accommodate a function can be easily performed in the in-vehicle ECU 101 or the like. Also, even in the case where an in-vehicle ECU 101 is added to the vehicle 1 after the vehicle 1 is shipped, setting for accommodating a function can be easily performed in the added in-vehicle ECU 101 similarly to the case of an in-vehicle ECU 101 installed in the vehicle 1 before shipment.

Therefore, the information processing method according to the embodiment of the present disclosure can easily accommodate an addition, change, or the like of a vehicle-related function.

Note that some or all of the functions of the management device 201 according to the embodiment of the present disclosure may be provided by cloud computing. In other words, the management device 201 according to the embodiment of the present disclosure may be a cloud server configured by a plurality of servers.

The foregoing embodiments are to be construed in all respects as illustrative and not restrictive. The scope of the present disclosure is defined by the claims rather than the description above, and is intended to include all modifications within the meaning and scope of the claims and equivalents thereof.

1. An information processing method in a management device, comprising the steps of:
creating setting information corresponding to a selected function and related to an in-vehicle component; and
transmitting the created setting information to a vehicle in which the in-vehicle component is installed.

2. The information processing method according to claim 1,
wherein in the step of creating the setting information, the setting information is created for performing, in respective vehicles, operation setting whose content differs for at least one of each vehicle model and each vehicle year.

3. The information processing method according to claim 2,
wherein the setting information is used in setting performed so that vehicle information regarding the vehicle is transmitted from the vehicle to the management device.

4. The information processing method according to claim 3,
wherein the vehicle information includes information regarding traveling of the vehicle.

5. The information processing method according to claim 3,
wherein the vehicle information includes information indicating a measurement result obtained in the vehicle.

6. The information processing method according to any one of claim 3,
wherein the setting information includes data position information used to specify the vehicle information in a frame transmitted or received in the vehicle.

7. The information processing method according to any one of claim 3,
wherein the setting information includes transmission timing information indicating a timing at which the vehicle information is to be transmitted to the management device.

8. The information processing method according to any one of claim 1,
wherein the management device stores correspondence information indicating a correspondence relationship between a plurality of functions and pieces of the setting information, and
in the step of creating the setting information, the correspondence information is referred to, and the piece of setting information corresponding to the selected function is acquired.

9. The information processing method according to any one of claim 1, further comprising the step of:
creating provision information to be used in executing the selected function, based on vehicle information regarding the vehicle, the vehicle information being received from the vehicle.

10. The information processing method according to any one of claim 1,
wherein the management device is a cloud server.

11. A communication system comprising:
a management device configured to create setting information corresponding to a selected function and related to an in-vehicle component, and transmit the created setting information to a vehicle in which the in-vehicle component is installed; and
an in-vehicle device configured to be installed in the vehicle, receive the setting information transmitted by the management device, and perform setting processing for the in-vehicle component based on the received setting information.

12. An information processing program product for use in a management device, the information processing program product comprising a non-transitory, machine-readable medium storing instructions which, when executed by at least one programmable processor, causes a computer to function as:
a creation unit configured to create setting information corresponding to a selected function and related to an in-vehicle component; and
a communication unit configured to transmit the setting information created by the creation unit to a vehicle in which the in-vehicle component is installed.
